(19) United States
(12) Patent Application Publication
(10) Pub. No.: US 2019/0301163 A1
(43) Pub. Date: Oct. 3, 2019

(54) Impact Resistant Waterproofing Material Having a Film Layer

(71) Applicant: TAMKO Building Products, LLC, Wilmington, DE (US)

(72) Inventor: Aaron R. Phillips, Baxter Springs, KS (US)

(73) Assignee: TAMKO Building Products, Inc., Joplin, MO (US)

(21) Appl. No.: 16/362,804

(22) Filed: Mar. 25, 2019

Related U.S. Application Data
(60) Provisional application No. 62/648,634, filed on Mar. 27, 2018.
(60) Provisional application No. 62/808,059, filed on Feb. 20, 2019.

(51) Int. Cl. E04D 5/10

(52) U.S. Cl. CPC E04D 5/10; B32B 7/022

(57) ABSTRACT

Disclosed is an impact resistant roofing and manufacturing lines for constructing impact resistant roofing. The impact resistant roofing utilizes a film layer that distributes the shock from impacts, such as hail stones, which assists in maintaining the structural integrity of the roofing material. The film can be placed adjacent to the substrate or embedded between asphalt layers.

### CROSS-REFERENCE TO RELATED APPLICATION

This Non-Provisional patent application claims the benefit of the Provisional U.S. Patent Application No. 62/648,634, entitled “Impact Resistant Roofing Having a Film Layer,” which was filed with the U.S. Patent & Trademark Office on Mar. 27, 2018, and of Provisional U.S. Patent Application No. 62/808,059 entitled “Continuous Nonwoven Polyester Fiber and Fiberglass Thread Hybrid Mat,” which was filed Feb. 20, 2019, both of which are specifically incorporated herein by reference for all that they disclose and teach.

### BACKGROUND OF THE INVENTION

Roofing technology and waterproof membrane technology has advanced greatly over the past few decades. Roof shingles and roll roofing provide protection for houses and buildings to prevent leakage of rain water into the interior of the building. Waterproof membranes provide protection under roofs, siding and to foundations. Various types of materials have been used to make waterproofing materials including asphalt and other materials. In addition, waterproofing materials have protected foundations and other surfaces from water penetration.

### SUMMARY OF THE INVENTION

An embodiment of the present invention may therefore comprise impact resistant waterproofing material comprising: a substrate comprising at least one fabric; a film layer disposed on the substrate that, in combination with the substrate, is capable of absorbing shock forces from impacts and dispersing the shock forces over a surface area of the film layer; a first asphalt layer disposed on the film; a second asphalt layer disposed on the substrate.

An embodiment of the present invention may further comprise a method of making impact resistant waterproofing material comprising: providing a substrate comprising at least one fabric; placing a film on the substrate, the film, in combination with the substrate, being capable of absorbing shock forces from impacts to the impact resistant roofing and dispersing the shock forces over a surface of the film; depositing a first layer of asphalt on the film; depositing a second layer of asphalt on the substrate.

An embodiment of the present invention may further comprise impact resistant roofing comprising: a substrate comprising at least one fabric; a first asphalt layer disposed on the substrate; a film layer disposed on the first asphalt layer that is capable, in combination with the substrate, of absorbing shock forces from impacts to the impact resistant roofing and dispersing the shock forces over a surface area of the film layer; a second asphalt layer disposed on the film layer; a third asphalt layer disposed on the substrate.

An embodiment of the present invention may further comprise a method of making impact resistant waterproofing material comprising: providing a substrate comprising at least one fabric; depositing a layer of bonding material on the substrate; placing a film on the layer of bonding material, the film, in combination with the substrate, being capable of absorbing shock forces from impacts to the impact resistant roofing and dispersing the shock forces over a surface of the film; depositing a first layer of asphalt on the film; depositing a second layer of asphalt on the substrate.

An embodiment of the present invention may further comprise a method of making impact resistant waterproofing material comprising: providing a substrate and a film bonded to the substrate to form a substrate film composite, the substrate film composite being capable of absorbing shock forces from impacts to the impact resistant roofing and dispersing the shock forces over a surface of the film; using the substrate film composite in a waterproofing material production facility to make the impact resistant waterproofing material.

### BRIEF DESCRIPTION OF THE DRAWINGS

FIG. 1 is a cross-sectional view of an embodiment of impact resistant roofing.

FIG. 2 is a schematic illustration of a side view of portions of a manufacturing line for making the embodiment of impact resistant roofing illustrated in FIG. 1.

FIG. 3 is a sectional view of another embodiment of impact resistant roofing.

FIG. 4 is a schematic side view of portions of a roofing manufacturing line for making the embodiment of impact resistant roofing of FIG. 3.

FIG. 5 is a schematic side view of an embodiment of portions of a manufacturing line for manufacturing another embodiment of impact resistant roofing.

FIG. 6 is a schematic cross-sectional view of another embodiment of impact resistant roofing.

FIG. 7 is a schematic side view of portions of an embodiment of a manufacturing line for constructing the embodiment of impact resistant roofing illustrated in FIG. 6.

FIG. 8 is a schematic cross-sectional view of another embodiment of impact resistant roofing.

FIG. 9 is a schematic side view of an embodiment of portions of a manufacturing line for manufacturing the embodiment of the impact resistant roofing of FIG. 8.

FIG. 10 is a schematic side view of an embodiment of a portion of a manufacturing line that illustrates the concept of film insertion, either before or after a dry looper.

FIG. 11 is a side schematic view of portions of an embodiment of a production line for making a composite substrate web.

### DETAILED DESCRIPTION OF THE EMBODIMENTS

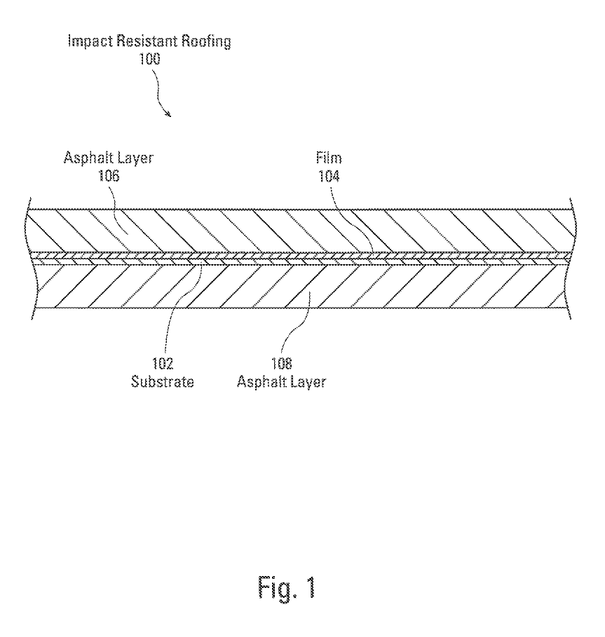

FIG. 1 is a schematic cross-sectional view of an embodiment of an impact resistant roofing product 100. As illustrated in FIG. 1, a substrate layer 102 is covered by a film layer 104. The substrate layer 102 can comprise a fabric. By way of example only, fabrics include standard organic felt material, such as used as substrates in roofing material, a fiberglass web, a polyester filament web or other polymer filament web. For example, other fabrics can be used to address issues of dimensional stability at process temperatures. These other fabrics can include polyester, polypropylene, polyethylene, polycarbonates, polybutylenes, polyvinyl chloride, carbon fiber composites, aramid and para-aramid (e.g. Kevlar). In its broadest sense, fabric includes any woven or non-woven cloth of organic or inorganic filaments, threads or yarns. These fabrics can be woven or nonwoven and can be spun-bond, point-bonded, stitch-bonded and thermally bonded. Film 104 may comprise polyester, polypropylene, polybutylene, polyimide, polycarbonate, polyamide, polyethylene, polystyrene, polyvinyl chloride, sulfone polymers, polyvinylidene chloride and other polymers. In addition, multi-layer composites of these materials can also be used. As many as three, five or even seven layers of these various polymers can be made as a single film composite layer that have various qualities and properties. Tying layers can also be used between the polymer films. In addition, custom composite layers can be made with specific combinations of these polymer films to provide the properties desired by the user including flexibility, shock absorption and weather proofing.

Also, the film may be perforated or have gaps. The perforations allow asphalt to penetrate completely through the film and attach to the underside of the film as a result of the penetration. Of course, the perforations should not remove a substantial amount of the film to the point where stress relief could no longer be provided by the film. In this manner, perforations or openings in the film can be provided as long as the film still provides stress relief. In that regard, U.S. Pat. No. 6,656,557 entitled “Waterproofing Membrane and Method of Manufacture,” is specifically incorporated herein for all that it discloses and teaches. The film is covered by an asphalt layer 106, while asphalt layer 108 covers the bottom side of the substrate 102.

When roofing materials are impacted by hail stones, rocks, branches, dropped hammers or other implements, etc. the structural integrity of the roofing material may be compromised. For example, the impact of hail stones may cause the fibers in a fiberglass substrate to crack, break or separate. The same is true for organic felt, in that the impact can reduce the structural integrity of the organic felt when impacted. Various attempts to remedy these situations have been generally ineffective. For example, polymer, oil and wax additives have been mixed with the asphalt layers to assist in softening the asphalt to seal cracks that occur in the asphalt layers. In that regard, the impacts from hail stones and other objects can cause cracks in the asphalt layers, especially when the asphalt is not in a softened state, but is more brittle and more susceptible to cracks being created when an impact occurs. This may occur when the roofing material is cooled by a rain shower and then impacted by hail stones. In addition, older asphalt in older roofing tends to become more brittle over time, which can result in cracks in the asphalt. Polymer, oil and wax additives, such as disclosed in U.S. Pat. No. 9,637,664 issued on May 2, 2017 by TAMKO Building Products entitled “Asphalt Upgrading Without Oxidation,” discloses various waxes, oils, polymers and other materials that can be used to soften asphalt. This patent is specifically incorporated herein, by reference, for all that it discloses and teaches. However, these processes have not solved these problems and micro cracks still tend to occur despite the use of these and other softening materials. Consequently, other more effective means can be used to make the roofing materials more impact resistant. These roofing materials may include shingles, roll roofing and other waterproofing materials, including peel and stick membranes, that are used to waterproof roofs, foundations, siding and any other type of waterproofing material. Waterproofing materials are manufactured by numerous different roofing companies and take many different constructions. The techniques utilized herein for providing impact resistance in roofing materials can additionally be used in various waterproofing products to provide impact resistance. In that regard, the term “waterproofing materials” as used herein includes roofing materials, waterproof membranes that can be used on roofs, under siding, on foundations or other locations requiring waterproofing.

Previous impact resistant roofing has used a fiberglass substrate with a film or fabric backing on the underside of the roofing. In other words, a scrim or layer of fabric or film is placed on the underside or backside of the roofing, such as a shingle, roll roofing or waterproofing membranes, to assist in the impact resistance and integrity of the waterproofing material. The standard for impact resistance is UL2218, which references classes I, II, III and IV. Class IV impact resistant products have been produced by placing this additional layer on the bottom or backside of the roofing material. In accordance with the present invention, a substrate and a reinforcement layer or film is placed or embedded in the interior portion of the shingle, i.e. within the asphalt layers. The combination of the layers improves impact resistance and helps to spread the shock forces of an impact over the surfaces of both of the layers to spread the shock forces and improve the impact resistance of the roofing.

Referring again to FIG. 1, the substrate 102 is a substrate that is used in roofing materials which comprises a fabric. A fabric is a woven or non-woven cloth of organic or inorganic filaments, thread or yarn. In that regard, the term “fabric” includes various textiles that are manufactured from staple fibers having finite lengths, and filaments which may have continuous lengths. Textiles are used in a variety of processes to form woven, knitted and non-woven or felt-like fabrics. In woven and knitted fabrics, the fibers and filaments are formed into continuous length yarns, which are then either interlaced by weaving or inter-looped by knitting into planar, flexible, sheet-like structures, which are known as fabrics. Non-woven fabrics are formed directly from fibers and filaments by chemically and/or physically bonding, or interlocking fibers that have been arranged in a planar configuration. Textile fibers include naturally occurring fibers such as vegetable fibers including cotton, linen, hemp, jute ramie, animal fiber such as wool, mohair, vicuna and other animal hairs, and silk. Mineral fibers include asbestos, fiberglass, etc. The other class of fibers are manufactured fibers, which include manufactured fibers based on natural, organic polymers. These include rayon, which is regenerated cellulose; lyocell, which also comprises regenerated cellulose; acetate, which comprises partially acetylated cellulose derivative; triacatate, which includes fully acetylated cellulose derivatives; and azlon, which comprises regenerated protein. Manufactured fibers also include fibers that are based on synthetic organic polymers. These include acrylic, which comprises polyacrylonitrile and modacrylic; aramids, which comprise aromatic polyamides; nylon, which comprises aliphatic polyamides; olefin, which comprises polyolefins such as polyethylene and polypropylene; polyesters, which comprises polyesters of aromatic dicarboxylic acids and dihydric alcohols; spandex, which comprises segmented polyurethane; vinyon, which comprises polyvinyl chloride; vinal which comprises polyvinyl alcohol; carbon/graphite, which is derived from polyacrylonitrile, rayon or pitch; and specialty fibers such as those based on polyphenylene sulfide, polyetheretherketone, polyimides and others. Manufactured fibers can also be based upon inorganic substances, such as glass, metallic or ceramic materials.

The use of continuous fibers provides greater strength and impact resistance to the substrate. In that regard, U.S. Patent Application 62/808,059 filed Feb. 20, 2019, entitled “Continuous Nonwoven Polyester Fiber and Fiberglass Thread Hybrid Mat,” by TAMKO Building Products, Inc. discloses the manner in which continuous fibers can be utilized to form a nonwoven substrate. This application claims the benefit of that application.

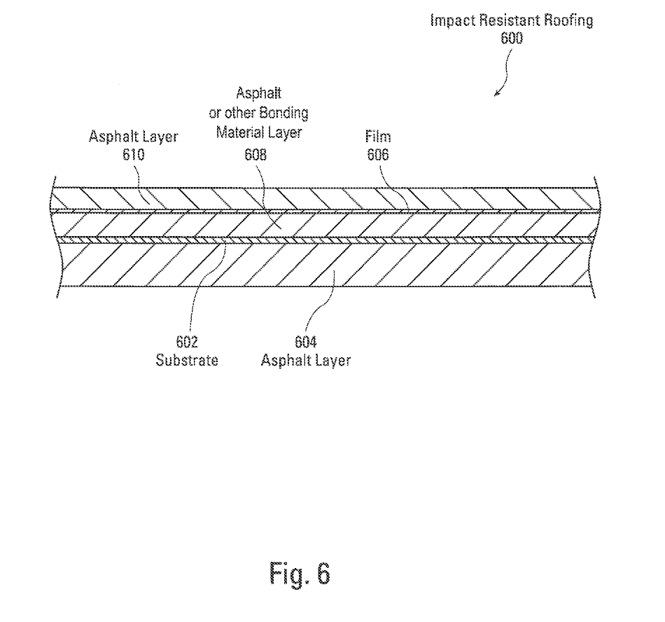

The production of manufactured fibers is based on three methods of fiber formation, or extrusion spinning. These methods include melt spinning, dry spinning and wet spinning, although there are many variations and combinations of these three basic processes. Nonwoven substrates can be bound together using mechanical interlocking using a process called needling or needle punching. Hydro-entanglement is an alternative process to needle punching, which can also be employed. The film 104 is placed over the substrate 102 and absorbs impacts to the roofing material. The nature of the film 104 is such that it absorbs impacts and functions in conjunction with the substrate 102 to protect the roofing including asphalt layer 108 from cracking, breaking and being structurally compromised. The film 104 can be simply placed over the substrate 102 or can be bonded to the substrate 102. Bonding can occur in several different ways, as explained below, especially with respect to the description of FIGS. 6, 7 and 8.

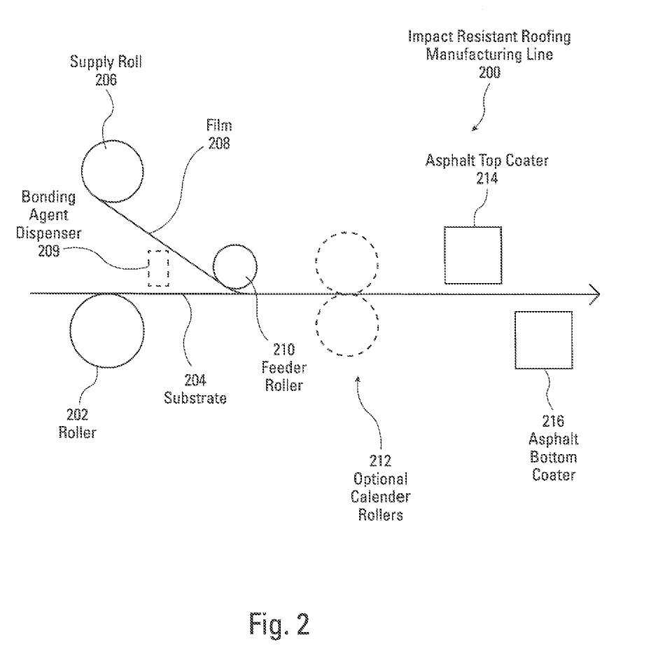

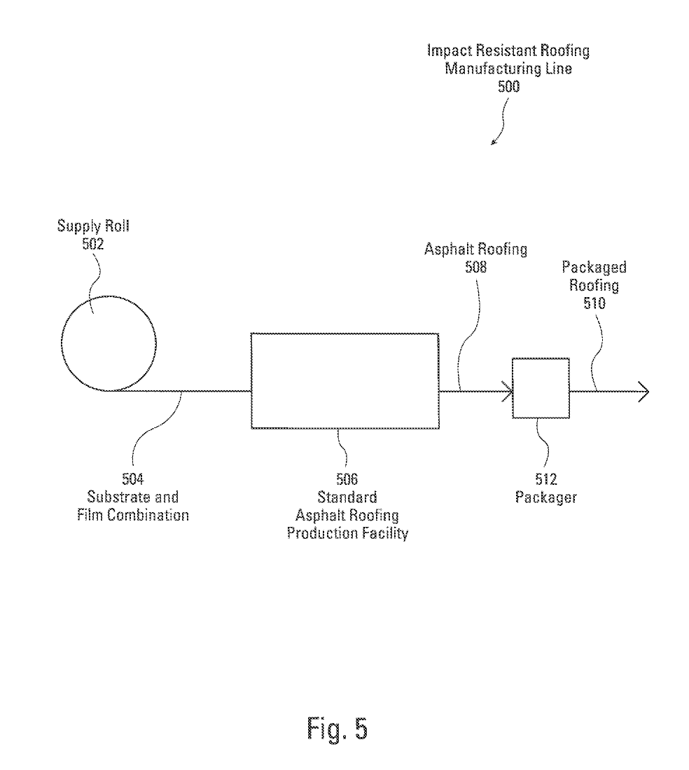

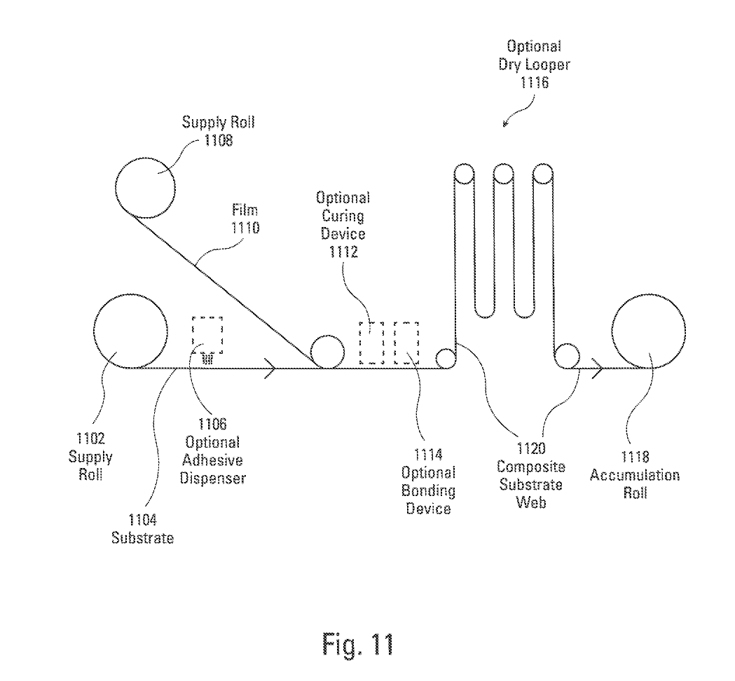

FIG. 2 is a schematic side view of a portion of an embodiment of a manufacturing line 200 for making the embodiment of the impact resistant roofing 100 of FIG. 1. As illustrated in FIG. 2, a roller 202 feeds the substrate 204 to the roofing manufacturing line 200. A supply roll 206 supplies a film 208 that is placed over the substrate by feeder roller 210. Optional calendar rollers 212 can be used to fuse the film 104 to the substrate 102. Alternatively, no bonding may occur. Bonding can also occur using an adhesive or other bonding agent dispensed from bonding agent dispenser 209. Asphalt top coater 214 supplies the asphalt layer 106 to the top of the combined film and substrate, while asphalt bottom coater 216 provides the bottom asphalt layer 108. Film 104 can be selected so that it has a softening temperature that causes the film 104 to soften and fuse to the substrate 102 when the asphalt top coater 214 supplies the hot asphalt to form the asphalt layer 106. Additionally, the substrate 204 and film 208 can be formed together at a factory so that the composite material can be utilized in a standard roofing material line, as disclosed in more detail below with respect to the description of FIG. 5 and FIG. 11.

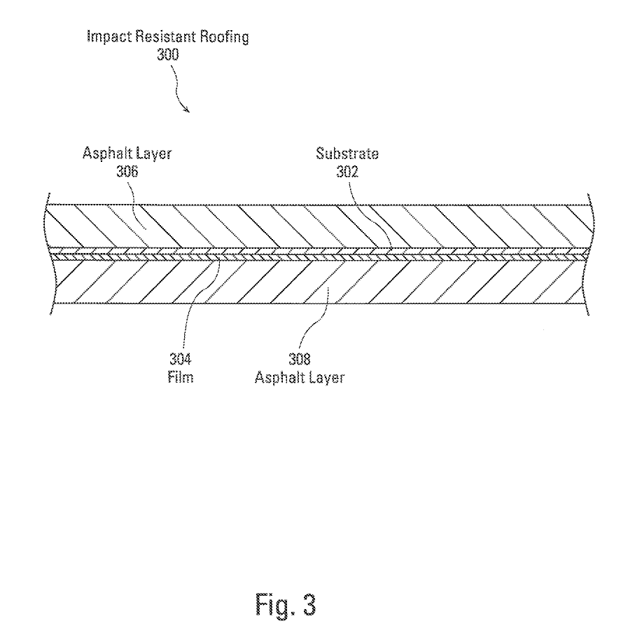

FIG. 3 is a schematic cross-sectional view of another embodiment of an impact resistant roofing product 300. As illustrated in FIG. 3, the impact resistant roofing 300 includes a substrate 302 which can comprise any of the substrates as mentioned above. Film 304 is placed on the bottom side of the substrate 302 and can comprise any of the film materials described above. Asphalt layer 306 coats the top side of the substrate 302, while asphalt layer 308 coats the bottom side of the film 304. The film 304, again, in conjunction with the substrate, acts as a buffer layer and absorbs impacts so that impacts are not transmitted through the asphalt layer 308. Film 304 assists in maintaining the integrity and strength of the substrate 302 and the combination of the film and the substrate spreads the forces of the impact over a greater surface area.

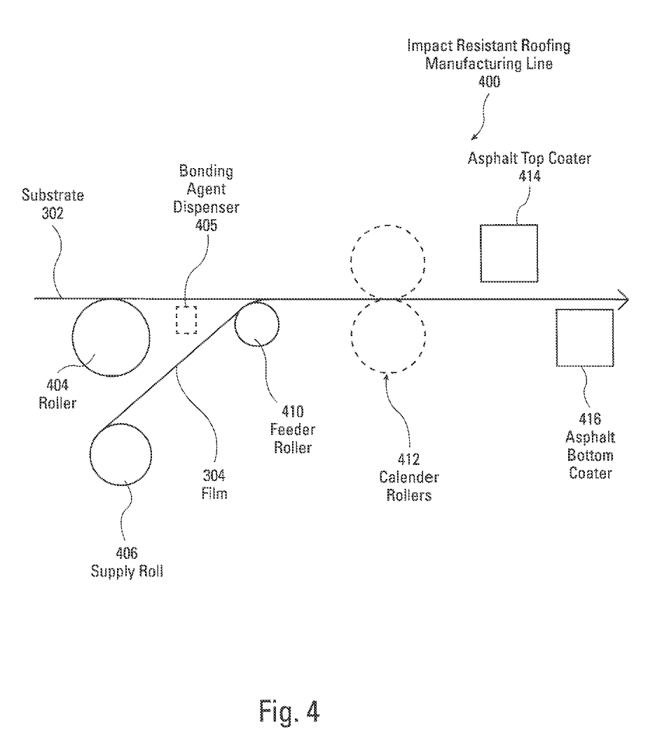

FIG. 4 is a schematic side view of a portion of an embodiment of an impact resistant roofing manufacturing line 400 for manufacturing the embodiment of the impact resistant roofing 300 of FIG. 3. As illustrated in FIG. 4, a substrate 302 is fed by a roller 404 into the manufacturing line 400. Supply roll 406 supplies film 304 to be placed on the bottom side of the substrate 302 with feeder roller 410. Optional calendar rollers 412 can be used to heat and compress the composite substrate 302 and film 304 to fuse the substrate 302 and film 304 together. Asphalt top coater 414 applies the top asphalt layer 306. Asphalt bottom coater 416 applies the asphalt layer 308. Adhesive or other bonding agents can also be used to bond the film 304 to the substrate 302 which can be dispensed from optional bonding agent dispenser 405.

FIG. 5 is a schematic side view of portions of an embodiment of an impact resistant roofing manufacturing line 500. As illustrated in FIG. 5, a supply roll 502 supplies a substrate and film combination 504 to a standard roofing production facility 506. The supply roll 502 is obtained from a production facility that provides a substrate and film combination or composite 504 that includes both a substrate and a film. The substrate and film composite 504 can be fused together or simply provided as two separate layers that are rolled together in the supply roll 502. So, rather than supplying the separate sheets of material and in some cases fusing the sheets of material together in the roofing line, a separate production facility, as illustrated in FIG. 11, can create the substrate and film combination 504 in a supply roll 502. The standard roofing production facility 506 produces the roofing material which may be roll roofing, shingles, waterproofing material for waterproofing foundations or other surfaces. The roofing material 508 is then transmitted to a packager 512 to produce the packaged roofing material 510.

FIG. 6 is a schematic cross-sectional view of an embodiment of an impact resistant roofing product 600. As illustrate in FIG. 6, a substrate 602 is coated with an asphalt layer 608 on the top portion of the substrate 602 and an asphalt layer 604 on the bottom layer of the substrate 602. A film layer 606 is deposited on the top of the asphalt layer 608. Asphalt layer 608 functions as an adhesive layer, which causes the substrate 602 to adhere to the asphalt layer 608. Asphalt layer 608 is a good adhesive and is convenient to use in a roofing production line. However, any desired bonding material can be used in place of the asphalt layer 608. For example, and not by way of limitation, hot melted adhesive, butyl rubber adhesive, polymer modified asphalt adhesive and similar adhesives can be utilized. There are a large number of adhesive types for various applications, which can be classified in a variety of ways depending upon the chemistries of these adhesives. For example, epoxies, polyurethanes, and polyamides are examples of various classes of adhesives. These adhesives may take the form of paste, liquid, films, pellets and tape. They may exist as a hot melt, a reactive hot melt, thermo-setting adhesives, thermo-sensing adhesives, or pressure contact adhesives. An additional asphalt layer 610 is placed on top of the film 606. In this manner, the film 606 is embedded between the asphalt layer 608 and the asphalt layer 610. The film 606, as disclosed above, absorbs impacts so that impacts on the asphalt layer 610 are not transmitted, to a large extent, through asphalt layer 608, substrate 602 or asphalt layer 604. As such, the structural integrity of the roofing product 600 illustrated in FIG. 6, is not compromised. Again, the film can comprise any of the film materials listed above that are capable of absorbing impacts and spreading the impacts across the surface of the film 606. By spreading the impacts out over the surface of the film 606, there is a greater absorption of these impacts and a lesser chance of compromising the structural integrity of the roofing material 600.

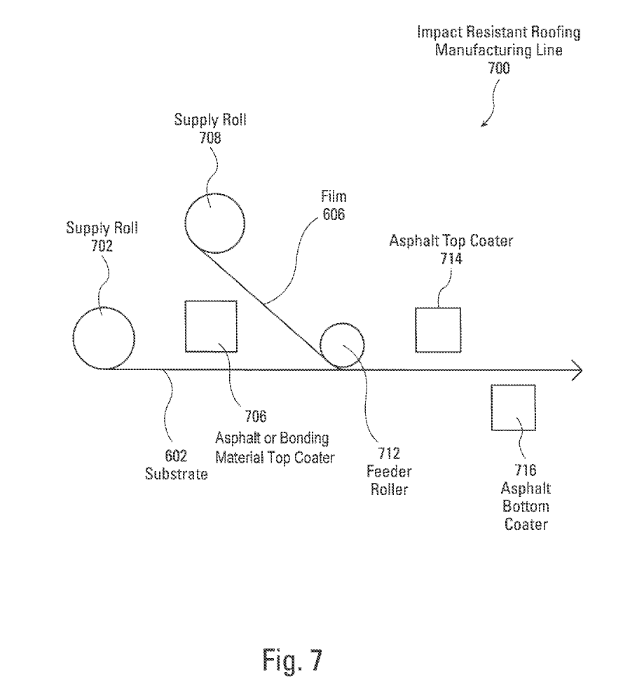

FIG. 7 is a schematic illustration of portions of an embodiment of an impact resistant roofing manufacturing line 700 that can be used to make the impact resistant roofing 600 of FIG. 6. As illustrated in FIG. 7, a supply roll 702 supplies a substrate 602. An asphalt top coater 706 applies the asphalt layer 608 to the top of the substrate 602. As disclosed above, with respect to FIG. 6, top coater 706 may comprise an asphalt or bonding material top coater 706 that coats substrate 602 with a bonding material. Supply roll 708 supplies film 606 to the feeder roller 712 which places the film 606 over the asphalt layer 608, illustrated in FIG. 6. An asphalt top coater 714 deposits another asphalt layer 610 (FIG. 6) on top of the film 606. Asphalt bottom coater 716 applies the bottom asphalt layer 604 (FIG. 6) on the substrate 602.

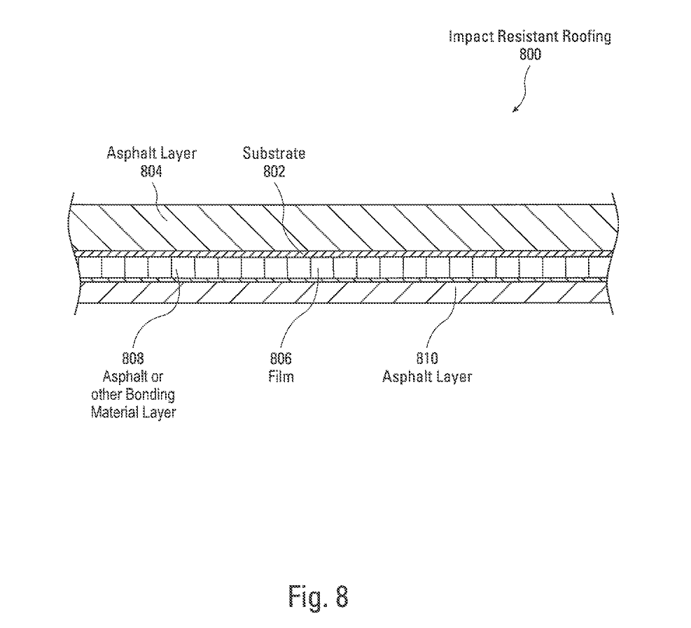

FIG. 8 is a schematic cross-sectional view of an embodiment of an impact resistant roofing product 800. As illustrated in FIG. 8, a substrate 802 has an asphalt layer 804 deposited on a top surface of the substrate 802. Asphalt layer 808 is applied to the bottom surface of the substrate 802. Asphalt or other bonding material layer 808 may comprise an asphalt bonding layer or a bonding layer using another bonding material in which the bonding material is deposited on the substrate 802. Any desired bonding material can be used that is capable of bonding the substrate 802 and the film layer 806. As also mentioned above, perforations can be provided in the film layer 806 to assist in the bonding of the film layer 806 to the layer 808. The same is also true for the film layer 606 of FIG. 6. Film 806 is applied to the asphalt layer 808. Asphalt layer 810 is applied to a bottom layer of the film 806. In this manner, the film 806 is embedded between the asphalt layer 808 and the asphalt layer 810. Again, the film 806 absorbs impacts in the impact resistant roofing 800 and spreads the shock of those impacts over the surface of the film 806. As such, the structural integrity of the impact resistant roofing product 800 is maintained.

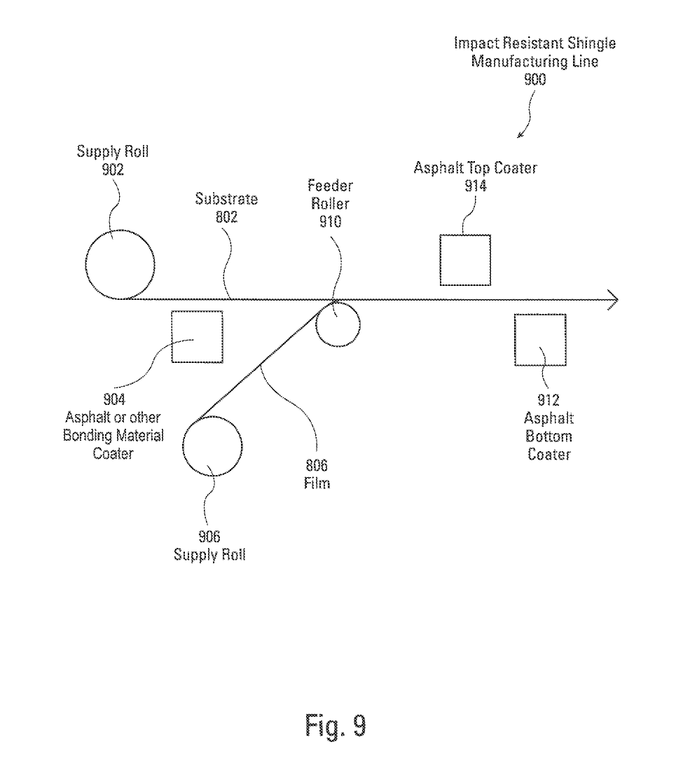

FIG. 9 is a schematic side view of an embodiment of portions of an impact resistant roofing manufacturing line 900 for constructing the embodiment of the impact resistant roofing 800 of FIG. 8. As illustrated in FIG. 9, a supply roll 902 supplies a substrate 802 to the manufacturing line 900. Asphalt bottom coater 904 places asphalt layer 808 on the bottom surface of the substrate 802. Supply roll 906 supplies film 806 to a feeder roller 910 that places the film 806 on the bottom surface of asphalt layer 808. Asphalt top coater 914 applies asphalt layer 804 to the top surface of the substrate 802. Asphalt bottom coater 912 applies asphalt layer 810 to the bottom surface of the film 806. The bottom and top layers of asphalt can be applied in any desired order.

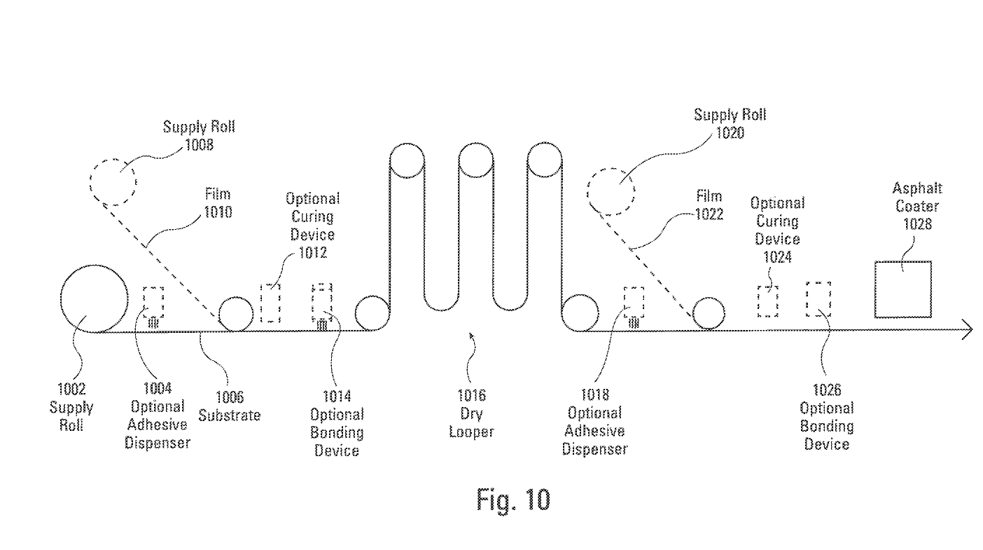

FIG. 10 is a schematic side view of an embodiment of a portion of a manufacturing line that illustrates the concept of film insertion, either before or after a dry looper 1016. Typical roofing production lines incorporate “dry” and “finish/finished” loopers, such as dry looper 1016. The dry looper allows sections of the production line to operate at different rates than the overall rate of the production line. The dry looper 1016 allows accumulation or depletion of the web in the dry looper 1016. This permits the line to continue to operate for short periods of time, as defined by the capacity of the looper, if something occurs that causes one section of the line to slow down or stop. The looper is designed to expand or contract the amount of the webbing, as needed, which provides time to correct the source of the stoppage or slow down.

As illustrated in FIG. 10, film 1010 can be inserted prior to the dry looper 1016. Alternatively, film 1022 can be inserted after the dry looper. Supply roll 1002 supplies a substrate 1006 to the manufacturing line. An optional adhesive dispenser 1004 can place an adhesive or other bonding agent on the substrate 1006. Supply roll 1008 supplies film 1010 to the substrate 1006. As shown, the film 1010 can be optionally supplied prior to entering the dry looper 1016. An optional curing device 1012 can be used to cure the adhesive or other bonding material placed on the substrate by the optional adhesive dispenser 1004. The optional curing device 1012 can constitute any type of curing device such as a heat source, a UV radiation emitter, or other device for curing adhesive or other bonding material that is disposed between the film 1010 and the substrate 1006. The optional curing device 1012 is used in conjunction with the optional adhesive or bonding dispenser 1004. Alternatively, an optional bonding device 1014 can be used to bond the film 1010 to the substrate 1006. The bonding device may be a heat source such as a flame bar, IR radiation heater, electric heater or other heat source which can soften or partially melt the film and/or substrate, so that the film 1010 bonds to the substrate 1006. The web then moves into the dry looper 1016, which functions as a buffer, as described above. The web then moves from the dry looper 1016 to the remaining portion of the manufacturing line, illustrated in FIG. 10.

As further illustrated in FIG. 10, if the film 1010 is not inserted prior to the dry looper 1016, the film 1022 can be inserted after the dry looper 1016. In that case, an optional adhesive dispenser 1018 can dispense adhesive or other bonding material on the substrate 1006. Supply roll 1020 supplies film 1022, which is placed on the substrate 1006. The optional curing device 1024 can be used to cure the adhesive or other bonding material placed between the film 1022 and the substrate 1006. Again, the optional curing device 1024 can be a heater of any desired type, as set forth above, or a UV radiation emitter that can be used to cure adhesives and other bonding materials that can be cured by UV light. Alternatively, an optional bonding device 1026 can be used if the adhesive is not placed on the substrate 1006. The optional bonding device 1026 can be a heat source, such as a flame bar, an infrared heater, an electric heater or other type of heater that softens or partially melts the film 1022 and/or the substrate 1006, so that the film 1022 and the substrate 1026 bond together when cooled. The composite film and substrate then move to asphalt coater 1028 which coats the composite web. Although the film 1010 and the film 1022 are both shown as being placed over the top of substrate 1006, the film 1010 and the film 1022 can be also placed on the underside of the substrate 1006. Alternatively, the film 1010 and film 1022 are not bonded to the substrate 1006.

FIG. 11 is a side schematic view of portions of an embodiment of a production line for making a composite substrate web 1120. FIG. 11 illustrates the concept of co-accumulation of the film 1110 and substrate 1104 in a fabric production site that is separate from a roofing production line. As illustrated in FIG. 11, a supply roll 1102 supplies a substrate 1104. An optional adhesive or bonding dispenser 1106 deposits adhesive or bonding material on the substrate 1104. Supply roll 1108 supplies film 1110, which is placed on the substrate 1104. Again, the film 1110 can be placed on the bottom surface of the substrate 1104, also. If adhesive or bonding material is placed between the film 1110 and substrate 1104, an optional curing device 1112 can be used to cure the adhesive or other bonding material. This can be done through heating, UV radiation or other curing techniques. Alternatively, an optional bonding device 1114 can be used. The optional bonding device 1114 may use various techniques for bonding the film 1110 and substrate 1104. For example, the optional bonding device 1114 may be a heat source, such as a flame bar, an IR heater, an electric heater or other type of heater, that softens or partially melts the film 1110 and/or the substrate 1104, to cause the film 1110 and substrate 1104 to bond when cooled. The optional dry looper 1116 allows time for the composite substrate web 1120 to cool and form the bond. The composite substrate web 1120 is then accumulated in accumulation roll 1118. Alternatively, the film 1110 and substrate 1104 may not be bonded together.

FIGS. 2, 4, 7, 9, 10 and 11 all show the substrate introduced first in the manufacturing line, and the film introduced second. This process can be reversed so that the film can be introduced first and the substrate second in accordance with the teachings of this invention.

Consequently, various embodiments disclosed herein use a protective film in various locations in the roofing product to maintain the structural integrity of roofing products and thereby increase impact resistance of the roofing products. The film utilized functions to spread the impact forces over a wider area in the roofing product to prevent cracking and breaking of the substrate and asphalt layers.

What is claimed is:

1. Impact resistant waterproofing material comprising:
a substrate comprising at least one fabric;
a film layer disposed on said substrate that, in combination with said substrate, is capable of absorbing shock forces from impacts and dispersing said shock forces over a surface area of said film layer;
a first asphalt layer disposed on said film;
a second asphalt layer disposed on said substrate.

2. The impact resistant waterproofing material of claim 1 further comprising:
a bonding agent that bonds said substrate and said film layer.

3. The impact resistant waterproofing material of claim 1 wherein said substrate is sufficiently porous that hot liquid asphalt disposed on said substrate penetrates said substrate to said film layer and cools to form said second asphalt layer that bonds to said substrate and said film layer.

4. The impact resistant waterproofing material of claim 1 wherein said film layer is disposed over a top surface of said substrate.

5. The impact resistant waterproofing material of claim 1 wherein said film layer is disposed over a bottom surface of said substrate.

6. The impact resistant waterproofing material of claim 1 wherein said impact resistant roofing comprises shingles.

7. The impact resistant waterproofing material of claim 1 wherein said impact resistant roofing comprises roll roofing.

8. The impact resistant waterproofing material of claim 1 wherein said impact resistant roofing comprises a waterproof membrane.

9. A method of making impact resistant waterproofing material comprising:
providing a substrate comprising at least one fabric;
placing a film on said substrate, said film, in combination with said substrate, being capable of absorbing shock forces from impacts to said impact resistant roofing and dispersing said shock forces over a surface of said film;
depositing a first layer of asphalt on said film;
depositing a second layer of asphalt on said substrate.

10. The method of claim 9 further comprising:
depositing a bonding agent between said film and said substrate that bonds said film to said substrate.

11. The method of claim 9 further comprising:
selecting said film that has a softening temperature that causes said film to bond to said substrate when hot liquid asphalt is applied to said film and allowed to cool.

12. The method of claim 9 wherein said process of depositing a second layer of asphalt on said substrate comprises:
depositing hot liquid asphalt on said substrate, said substrate being sufficiently porous that said liquid asphalt penetrates said substrate and contacts said film and bonds said film and said substrate when said hot liquid asphalt cools.

13. The method of claim 9 wherein said film is placed on a top surface of said substrate.

14. The method of claim 9 wherein said film is placed on a bottom surface of said substrate.

15. The method of claim 9 wherein said impact resistant waterproofing material comprises impact resistant shingles.

16. The method of claim 9 wherein said impact resistant waterproofing material comprises impact resistant roll roofing.

17. The method of claim 9 wherein said impact resistant waterproofing material comprises impact resistant membrane material.

18. Impact resistant roofing comprising:
a substrate comprising at least one fabric;
a first asphalt layer disposed on said substrate;
a film layer disposed on said first asphalt layer that is capable, in combination with said substrate, of absorbing shock forces from impacts to said impact resistant roofing and dispersing said shock forces over a surface area of said film layer;
a second asphalt layer disposed on said film layer;
a third asphalt layer disposed on said substrate.

19. The impact resistant roofing of claim 18 wherein said first asphalt layer is disposed on a top surface of said substrate.

20. The impact resistant roofing of claim 18 wherein said first asphalt layer is disposed on a bottom surface of said substrate.

21. A method of making impact resistant waterproofing material comprising:
providing a substrate comprising at least one fabric;
depositing a layer of bonding material on said substrate;
placing a film on said layer of bonding material, said film, in combination with said substrate, being capable of absorbing shock forces from impacts to said impact resistant roofing and dispersing said shock forces over a surface of said film;
depositing a first layer of asphalt on said film;
depositing a second layer of asphalt on said substrate.

22. The method of claim 21 wherein said method of depositing said layer of bonding material comprises depositing a third layer of asphalt.

23. The method of claim 21 wherein said method of depositing said layer of bonding material comprises depositing a layer of adhesive on a bottom surface or a top surface of said substrate.

24. The method of claim 21 wherein said method of making impact resistant waterproofing material comprises making impact resistant roofing shingles.

25. The method of claim 21 wherein said method of making impact resistant waterproofing material comprises making impact resistant roll roofing.

26. The method of claim 21 wherein said method of making impact resistant waterproofing material comprises making impact resistant membranes.

27. A method of making impact resistant waterproofing material comprising:
providing a substrate and a film bonded to said substrate to form a substrate film composite, said substrate film composite being capable of absorbing shock forces from impacts to said impact resistant roofing and dispersing said shock forces over a surface of said film;
using said substrate film composite in a waterproofing material production facility to make said impact resistant waterproofing material.

28. The method of claim 27 wherein said method of using said substrate film composite comprises using said substrate film composite in a shingle production facility to make impact resistant shingles.

29. The method of claim 27 wherein said method of using said substrate film composite comprises using said substrate film composite in a roll roofing production facility to make impact resistant roll roofing.

30. The method of claim 27 wherein said method of using said substrate film composite comprises using said substrate film composite in a waterproof membrane production facility to make impact resistant waterproof membranes.
